(19) United States
(12) Patent Application Publication
(10) Pub. No.: US 2016/0304401 A1
(43) Pub. Date: Oct. 20, 2016

(54) Magnesium Based Cement Board Composition to Lower Thermal Conductivity

(71) Applicant: Jerry Gillman, Davie, FL (US)

(72) Inventor: Jerry Gillman, Davie, FL (US)

(21) Appl. No.: 15/134,125

(22) Filed: Apr. 20, 2016

Related U.S. Application Data
(60) Provisional application No. 62/150,003, filed on Apr. 20, 2015.

(51) Int. Cl. C04B 28/30; C04B 14/22

(52) U.S. Cl. CPC C04B 28/30; C04B 14/22

(57) ABSTRACT

A magnesium based cement board composition to lower thermal conductivity includes a magnesium based cement mixture and a plurality of microspheres. The plurality of microspheres is heterogeneously mixed to the magnesium based cement mixture during the manufacturing process of the magnesium based cement board. The plurality of microspheres is able to reduce shrinkage of the magnesium based cement board during the manufacturing process. Additionally, the plurality of microspheres is able to increase the loading and strength of the magnesium based cement boards and reduces the thermal conductivity of the magnesium based cement boards. As a result, the plurality of microspheres can create an efficient manufacturing process and a low thermal conductivity magnesium based cement board with an acceptable moisture content that allows application of common paint and coatings without the need for special primers and bounding agents.

The current application claims a priority to the U.S. Provisional Patent application Ser. No. 62/150,003 filed on Apr. 20, 2015.

### FIELD OF THE INVENTION

The present invention relates generally to a magnesium based cement board composition. More specifically, the present invention relates generally to an improved magnesium oxide and/or magnesium based cement board composition that produce a high temperature magnesium based cement board to drastically decrease thermal conductivity while reducing high moisture content which is an inherent issue with magnesium based cement boards.

### BACKGROUND OF THE INVENTION

Magnesium Oxide Board (MGO) or magnesium oxide commonly called magnesia is a versatile mineral and is used as part of a MGO cement mixture. The MGO cement mixture casts into thin cement panels under proper curing procedures so that the MGO boards can be used in residential and commercial building construction. Some versions are suitable for a wide range of general building uses and for applications that require fire resistance, mold and mildew control, as well as sound control applications and many other benefits over drywall. As an environmentally friendly building material, the MGO boards have relatively high strength characteristic due to strong bonds between magnesium and oxygen atoms that form the magnesium oxide molecules (chemical symbol MgO). Many common recipes for manufacturing MGO board exist with minor variations between different manufactures and board types. However, the general composition for the MGO boards requires a combination of the following raw materials, wherein the exact amount of each ingredient used is proprietary to each manufactures variation of the following ingredients:

Magnesium Oxide-MgO (burnt Magnesia)

Magnesium Chloride (MgC12) or suitable replacement

Talcum Powder

Alpha Cellulose Material

Perlite, sawdust, or other lightweight filler

Fiber Cloth

Non-woven cloth

Foaming agents

Additional agents

These MGO boards are used in place of traditional gypsum drywall as wall and ceiling covering material and sheathing. It is also used in a number of other construction applications such as: fascia's, soffit, shaft-liner & area separation, wall and roof sheathing, and as tile backing (backer board) or as substrates for coatings and insulated systems such as Finish Systems, exterior insulation and finishing system, structural insulated panels, and some types of stucco applications. The MGO boards for building construction are available in various sizes and thickness and is not a paper faced material. Numerous versions and value of grades exist including smooth face, rough texture, utility, versatile grades as well as different densities and strengths for different applications and uses.

One of the biggest problems with all MGO boards is that they transmit heat through the board to the structural element of the building and the boards tend to have high and unstable moisture content. For example, the MGO boards typically have a moisture content of 20% or more making application of paint and other coatings a challenge. As a result, primers and other bonding agents are required to ensure a good bond for the applying paint and other common finish coatings. Although most MGO boards are highly fire resistant, MGO board transfers heat through the board to framing members or other structural members thus creating a critical problem for most building structures, including many types of fire rated building assemblies.

It is objective of the present invention to improve the traditional MGO boards so that the improved magnesium based cement boards that are formed by the preset invention reduce the thermal conductivity. More specifically, the present invention introduces a plurality of microspheres into the existing the magnesium based cement mixture so that the produced magnesium based cement boards are able to increase overall loading and strength while simultaneously reducing the thermal conductivity and moisture content of the board to an acceptable level.

### BRIEF DESCRIPTION OF THE DRAWINGS

FIG. 1 is a schematic illustration of the present invention showing the magnesium based cement mixture and the plurality of microspheres.

FIG. 2 is a basic illustration showing the magnesium based cement mixture and the plurality of microspheres within the low thermal conductivity magnesium based cement board.

### DETAIL DESCRIPTIONS OF THE INVENTION

All illustrations of the drawings are for the purpose of describing selected versions of the present invention and are not intended to limit the scope of the present invention.

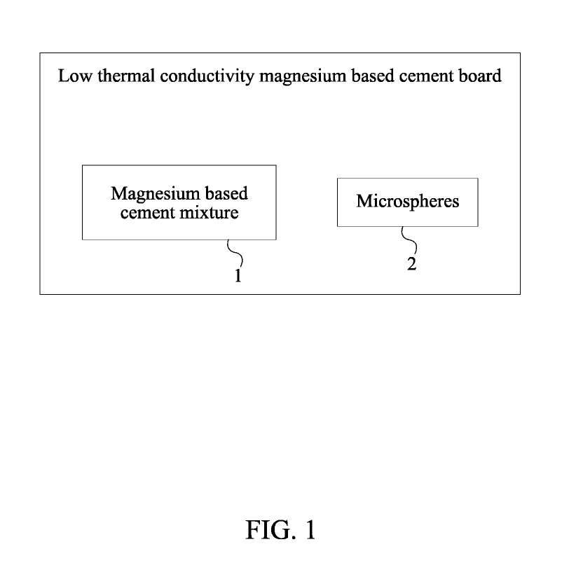

The present invention is a magnesium based cement board composition to lower thermal conductivity. The present invention comprises a magnesium based cement mixture 1 and a plurality of microspheres 2, as shown in FIG. 1. Components of the present invention results in a low thermal conductivity magnesium based cement board from a manufacturing process of magnesium based cement board, wherein the plurality of microspheres 2 may or may not replace some of the common magnesium oxide (MGO) board fillers utilized within the manufacturing process.

The magnesium based cement mixture 1 generally comprises magnesium oxide-MgO (burnt magnesia), magnesium chloride (MgC12) or acceptable replacement, talcum powder, alpha cellulose material, perlite, fiber cloth, non-woven cloth, foaming agents, and additional agents. However, the exact amount of each ingredient used can and is different from one manufacture to another with the addition and/or subtraction of the aforementioned or other similar ingredients.

The plurality of microspheres 2, sometimes also referred as micro balloons, microbubbles or micro particles, can be made of glass microspheres or ceramic microspheres. Each of the plurality of microspheres 2 has a preferable diameter range between a 1 micrometer to 1000 micrometers and is hollow on the inside. In reference to

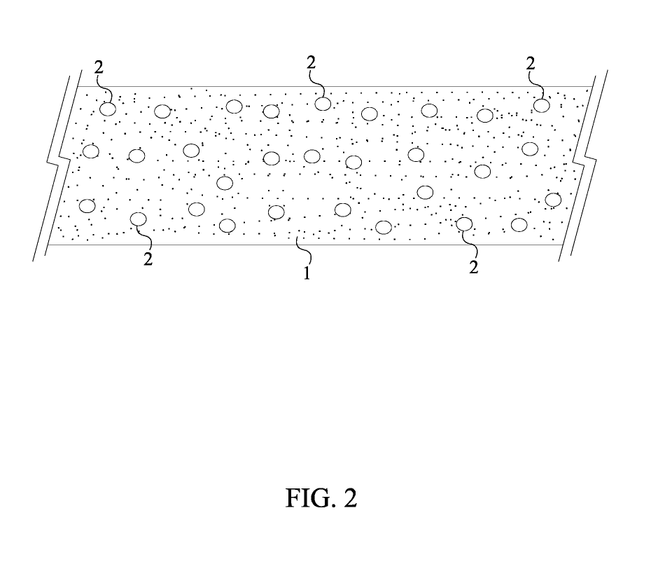

FIG. 2, the plurality of microspheres 2 is heterogeneously mixed to the magnesium based cement mixture 1 during the manufacturing process in order to attain the low thermal conductivity magnesium based cement board. Addition of the plurality of microspheres 2 helps stabilize and lower the moisture content of the magnesium based cement board which in return reduces the shrinkage of the magnesium based cement board during the manufacturing process. In other words, the plurality of microspheres 2 improves the viscosity and flow of the present invention, improving the overall efficiency of the manufacturing process. Addition of the plurality of microspheres 2 also increases the loading and overall strength of the magnesium based cement board after the manufacturing process. As a result, the low thermal conductivity magnesium based cement board is able provide a superior magnesium based cement board compared to the traditional MGO board. Addition of the plurality of microspheres 2 also substantially reduces and lowers the thermal conductivity of the low thermal conductivity magnesium based cement board to an acceptable temperature range. For example, in an event of building fire, the low thermal conductivity magnesium based cement boards are not only able to block fire, but also are able to minimize heat transfer to other building materials. As a result, the low thermal conductivity magnesium based cement boards create a safe escape route or a safe gathering area for the trapped individuals. Since the weight percentage of the plurality of microspheres 2 directly correlates with the decrease heat transfer rate of the low thermal conductivity magnesium based cement board, the present invention utilizes the accurate amount of the plurality of microspheres 2 within the present invention without compromising the structural integrity of the low thermal conductivity magnesium based cement board.

The two main disadvantages of the traditional MGO board are the high moisture rate and the unacceptable thermal conductivity compare to some of the other building structural panel. However, addition of the plurality of microspheres 2 is able to overcome these two disadvantages within the low thermal conductivity magnesium based cement board. In addition, the lower moisture content of the low thermal conductivity magnesium based cement board solves any problems regarding painting and application of other finish coatings without the need for special primers and bonding agents.

Even though the present invention is explained in relation to the low thermal conductivity magnesium based cement board, it is understood that the magnesium based cement mixture 1 and the plurality of microspheres 2 can be heterogeneously mixed together to manufacture magnesium based roof tiles, magnesium based acoustic ceiling tiles, magnesium based insulations, and any other similar products. Although the invention has been explained in relation to its preferred embodiment, it is to be understood that many other possible modifications and variations can be made without departing from the spirit and scope of the invention as hereinafter claimed.

What is claimed is:

1. A magnesium based cement board composition to lower thermal conductivity comprises:
a magnesium based cement mixture;
a plurality of microspheres; and
the plurality of microspheres being heterogeneously mixed to the magnesium based cement mixture, during a manufacturing process of magnesium based cement board.

2. The magnesium based cement board composition to lower thermal conductivity as claim in claim 1, wherein the plurality of microspheres reduces shrinkage of a magnesium based cement board during the manufacturing process.

3. The magnesium based cement board composition to lower thermal conductivity as claim in claim 1, wherein the plurality of microspheres stabilizes and lowers the moisture content of a magnesium based cement board after the manufacturing process.

4. The magnesium based cement board composition to lower thermal conductivity as claim in claim 1, wherein the plurality of microspheres increases the loading and overall strength of a magnesium based cement board after the manufacturing process.

5. The magnesium based cement board composition to lower thermal conductivity as claim in claim 1, wherein the plurality of microspheres reduces the thermal conductivity of a magnesium based cement board after the manufacturing process.

6. The magnesium based cement board composition to lower thermal conductivity as claim in claim 1, wherein the plurality of microspheres reduces being glass microspheres.

7. The magnesium based cement board composition to lower thermal conductivity as claim in claim 1, wherein the plurality of microspheres reduces being ceramic microspheres.

8. A magnesium based cement board composition to lower thermal conductivity comprises:
a magnesium based cement mixture;
a plurality of microspheres;
the plurality of microspheres being heterogeneously mixed to the magnesium based cement mixture, during a manufacturing process of magnesium based cement board; and
wherein the plurality of microspheres reduces the thermal conductivity of a magnesium based cement board after the manufacturing process.

9. The magnesium based cement board composition to lower thermal conductivity as claim in claim 8, wherein the plurality of microspheres reduces shrinkage of a magnesium based cement board during the manufacturing process.

10. The magnesium based cement board composition to lower thermal conductivity as claim in claim 8, wherein the plurality of microspheres stabilizes and lowers the moisture content of a magnesium based cement board after the manufacturing process.

11. The magnesium based cement board composition to lower thermal conductivity as claim in claim 8, wherein the plurality of microspheres increases the loading and overall strength of a magnesium based cement board after the manufacturing process.

12. The magnesium based cement board composition to lower thermal conductivity as claim in claim 1, wherein the plurality of microspheres reduces being glass microspheres.

13. The magnesium based cement board composition to lower thermal conductivity as claim in claim 8, wherein the plurality of microspheres reduces being ceramic microspheres.

14. A magnesium based cement board composition to lower thermal conductivity comprises:
a magnesium based cement mixture;
a plurality of microspheres;
the plurality of microspheres being heterogeneously mixed to the magnesium based cement mixture, during a manufacturing process of magnesium based cement board;
wherein the plurality of microspheres reduces the thermal conductivity of a magnesium based cement board after the manufacturing process; and
wherein the plurality of microspheres stabilizes and lowers the moisture content of a magnesium based cement board after the manufacturing process.

15. The magnesium based cement board composition to lower thermal conductivity as claim in claim 14, wherein the plurality of microspheres reduces shrinkage of a magnesium based cement board during the manufacturing process.

16. The magnesium based cement board composition to lower thermal conductivity as claim in claim 14, wherein the plurality of microspheres increases the loading and overall strength of a magnesium based cement board after the manufacturing process.

17. The magnesium based cement board composition to lower thermal conductivity as claim in claim 14, wherein the plurality of microspheres reduces being glass microspheres.

18. The magnesium based cement board composition to lower thermal conductivity as claim in claim 14, wherein the plurality of microspheres reduces being ceramic microspheres.
